(19) United States
(12) Patent Application Publication
(10) Pub. No.: US 2008/0053288 A1
(43) Pub. Date: Mar. 6, 2008

(54) Bracing and bridge system for stringed instruments

(76) Inventor: Martin Frank Brunkalla, Marengo, IL (US)

Correspondence Address: Martin F. Brunkalla, 8015 S. Hill Rd., Marengo, IL, 60152-8252, US

(21) Appl. No.: 11/516,471

(22) Filed: Sep. 6, 2006

(51) Int. Cl. G10D 1/08

(52) U.S. Cl. 84/267

(57) ABSTRACT

The invention pertains to improvements in stringed instruments, particularly plucked and/or strummed instruments with sound boxes and the string support structure of same. The invention also pertains to enhancing the sound output of the instrument. A string support system that is structurally independent of the sound box eliminates the necessity to brace, or otherwise reinforce the soundboard to resist the substantial tension of the strings, thus substantially reducing the soundboards stiffness and mass, and greatly improving its ability to respond to the vibration of the strings. Furthermore, the invention enables the transmission of vibrating string energy to the soundboard without imposing any stresses upon said soundboard that are due to the static tension of the strings. The invention eliminates tension-induced distortion and damage to the sound box that is common to traditionally constructed instruments.

### CROSS REFERENCE TO RELATED APPLICATION

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of stringed instruments, and more specifically to a novel bracing and bridge system for stringed instruments having a sound box.

Traditionally, stringed instruments, and, for the purposes of this disclosure, particularly acoustic guitars and similar instruments, have been designed and constructed to be aesthetically and acoustically pleasing, as well as substantial enough to function reliably for as long as possible. In order to be heard, the strings of acoustic instruments are stretched to a substantial tension. Through history, as musicians desired greater volume of sound from their instruments, string tensions increased, as did the strength of the the instruments that had to bear the tension. Strings of animal hair or intestines gave way to steel and high-strength synthetic materials, and instruments gained bracing and bulk to resist distortion and damage caused by the increased tension. Unfortunately, these two design criteria are at cross-purposes. Modern materials, manufacturing methods, and analysis tools have helped to minimize the compromise between these two conflicting design elements. However, with few exceptions, the sounding boards of modern instruments are braced much as they have been for the last 100 years or so.

In particular, acoustic guitar designs have traditionally put the greatest structural demand on the top, or soundboard, of the instrument, which is most often constructed of a thin spruce plate, upon which is glued a bridge, to which the strings are anchored. With average, modern strings, the static string tension is about 0188 pounds, all of which is trying to remove the bridge and/or top plate of the instrument. This tension is also inhibiting the movement of the soundboard, effectively damping its ability to respond to the vibrations of the strings. Bracing that is intended to reinforce the soudboard of the guitar further inhibits its ability to respond to the vibration of the strings. This effect can be demonstrated by placing your fingers against the cone of a vibrating loudspeaker. The more pressure you apply, the quieter the speaker becomes. It will be observed that it takes very little pressure to substantially reduce the output of the speaker. If a weight, such as a penny is fastened to the speaker cone, this too will substantially reduce the output of the speaker, much as adding bracing to a soundboard increases its mass, and reduces its ability to vibrate. Over time, due to inferior construction, temperature and humidity extremes, careless handling, or combinations of all of the above, failures of bridges and soundboards are not uncommon. More common is the detrimental effect that persistent tension has on the entire structure of a guitar, particularly, the sound box. Distortion of the instrument eventually leads to undesirable playing characteristics, expensive repairs, and in the extreme, catastrophic structural failure.

Numerous ideas have been implemented to address the issue of structure vs. sound output. Alternate materials, such as carbon fiber, have been used to construct a top and/or bracing that is lightweight, and strong enough to resist the tension of the strings for the foreseeable future. However, this does not address the issue of string tension inhibiting the movement of the soundboard. Again, alternate bracing materials and/or configurations can reduce the mass and/or increase the strength of the soundboard (U.S. Pat. Nos. 4,464,970; 6,459,024; 6,833,501; 6,943,283), but compared with the great tension imposed by the strings, the improvement is small. A more ambitious attempt to free up the soundboard (U.S. Pat. No. 4,169,402) suspends the sound box in an external frame, routes the strings over a bridge/tailpiece combination, and presses this device to the top of the guitar to transmit vibrations to it. Again, pressure is being applied to the soundboard, thus inhibiting its movement, though less so than the aforementioned inventions. The external metal frame that is described in this patent, as well as the system of connecting/suspension components, are a complex and aesthetically drastic departure from traditional guitar construction. As a luthier I have found that the vast majority of acoustic guitar enthusiasts prefer an instrument resembling more familiar, traditional guitar designs, which by consensus are considered aesthetically pleasing.

There have been many designs which incorporate a “tailpiece” which is a device that is usually attached to the end of the guitar body, is compliant enough to conform to the angle at which the strings pull on it, serves as an anchor point for one end of the strings, and carries a great deal of the tension. This configuration still requires that substantial pressure be applied to the bridge in order to cleanly transmit string vibrations to the guitars soundboard. Again, pressure applied to the soundboard inhibits it's response to the strings vibrations.

The objective of this invention is to address the negative effects of string tension on the structure and sound production of stringed instruments, particularly in this embodiment, acoustic guitars. The invention eliminates distortion and damage to the sound box that is normally associated with persistent string tension, and does so without imposing any tension or pressure to the soundboard, or to the sound box as a whole. At the same time, the invention eliminates the need for bracing of the soundboard for structural purposes, thus greatly reducing its mass and stiffness. As a consequence, the soundboard responds to the vibration of the strings more quickly, and with substantially increased movement, thus greater amplitude.

Prior technology has made some improvements to traditional guitar construction in attempts to address the negative effects of string tension on sound output and durability of the sound box, though to my knowledge, none has completely eliminated these effects. The invention succeeds in addressing these effects in their totality, while at the same time substantially preserving the aesthetic of a traditionally constructed acoustic guitar. In addition to these benefits, the invention simplifies manufacturing and provides a more consistent product, in spite of the inherent variability of traditional construction materials, specifically, wood. Additionally, the negative effects of varying humidity on the tuning stability of the instrument are greatly reduced.

### BRIEF SUMMARY OF THE INVENTION

The primary object of the invention is to provide a stringed instrument with improved structural integrity.

Another object of the invention is to provide a stringed instrument with enhanced sound output.

Another object of the invention is to provide a bracing and bridge system that enables customization of the tonal qualities of the sound box without regard for the structural consequences as they relate to string tension.

A further object of the invention is to provide a bracing and bridge system that increases sustain, that is, the length of time a note sounds for a given energy input.

Yet another object of the invention is to provide a bracing and bridge system that improves the immediacy of the soundboard's response to the player's manipulation of the strings.

Still yet another object of the invention is to provide a bracing and bridge system that reduces the number of variables affecting the performance of a stringed instrument which are due to the inherent variability in the materials used in traditional stringed instrument construction, in particular, wood.

Another object of the invention is to provide a bracing and bridge system that simplifies manufacturing.

Another object of the invention is to provide a bracing and bridge system that eliminates distortion of the sound box, in particular the soundboard, due to the persistent static tension of the strings.

A further object of the invention is to provide a bracing and bridge system that simplifies the changing of strings as compared to a traditional pin bridge.

Yet another object of the invention is to provide a bracing and bridge system that improves tuning stability with regard to distortion of the sound box due to temperature and humidity variation.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Bracing and Bridge System for stringed instruments with sound boxes, in particular, acoustic guitars comprising: A rigid framework, internal to the sound box, of sufficient strength to bear the total tension of the strings without distortion, structurally independent of the sound box, but providing mounting surfaces for the sound box and neck of the instrument, A novel “bridge” that directs the vibrating string energy to the sound board without imposing stresses to the sound board that are due to the static tension of the strings, and A novel “tailpiece” that by virtue of its precise alignment and rigid mounting to the rigid frame directs the force of the static tension of the strings to the rigid frame, without imposing stresses to the sound board that are due to the static tension of the strings, as well as performing the common function of providing an attachment point for one end of the strings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of an acoustic guitar according to the invention, with internal components represented in dashed lines;

FIG. 2 is a side elevational view of an acoustic guitar according to the invention, with internal components represented in dashed lines;

FIG. 3 is a plan view of the tension-bearing components of the guitar according to the invention, with sound box and fretboard removed;

FIG. 4 is a side elevational view of the tension-bearing components of the guitar according to the invention, with sound box and fretboard removed;

FIG. 5 is a perspective view of the rigid framework according to the invention, with the sound box of the guitar superimposed in phantom lines;

FIG. 6 is a plan view of the bridge according to the invention;

FIG. 7 is a front elevational view of the bridge;

FIG. 8 is a cross sectional view of the bridge as defined by A-A in FIG. 6;

FIG. 9 is a perspective, cross sectional view of the bridge, at the same point defined by A-A in FIG. 6;

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

For the purpose of this disclosure, unless otherwise indicated, identical reference numerals used in different figures refer to the same component.

This invention relates to a bridge and bracing system for stringed instruments with sound boxes. For the purposes of description, the preferred embodiment is illustrated as an acoustic guitar. Also, for the purposes of this disclosure, the terms “acoustic guitar” and “guitar” will refer to the same object.

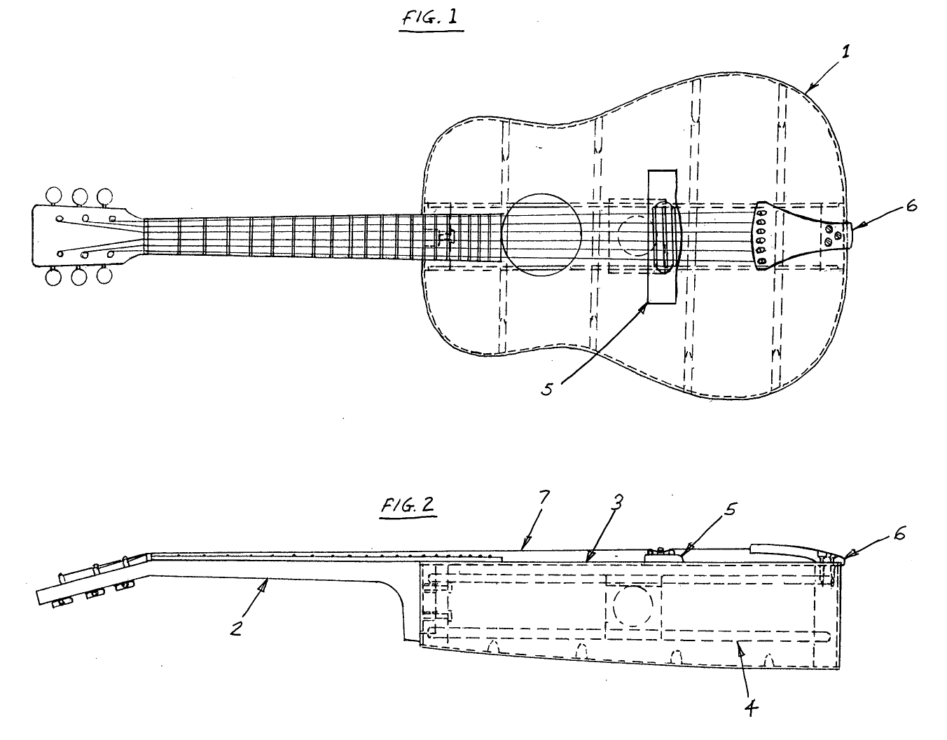

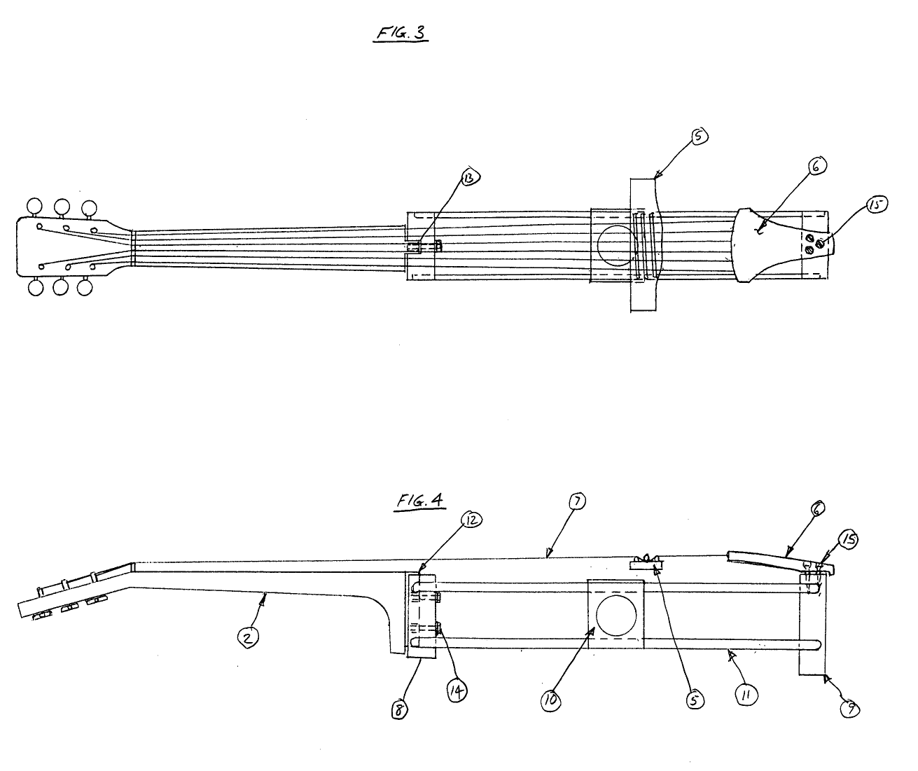

As shown in FIG. 1 and FIG. 2, the acoustic guitar according to the invention comprises two major assemblies, the sound box 1, and the neck 2. This basic configuration is generally typical of all acoustic guitars. In a traditionally constructed guitar, the primary sound producing element is the top, or soundboard 3. Traditionally, the sound box 1, and in particular the soundboard 3 are constructed in such manner as to resist the tension of the strings 7 without distorting to a degree which would adversely effect the playing characteristics of the instrument. At the same time, the degree of freedom with which the soundboard 3 can flex, directly influences the volume and quality of sound that is produced by the instrument. For this reason, in traditionally constructed guitars, a compromise is sought between reinforcing the soundboard 3 sufficiently to resist the tension of the strings 7, and making it sufficiently light and flexible enough to vibrate easily. The primary objective of the invention is to eliminate the necessity to brace, or otherwise reinforce the soundboard 3 to resist the static tension of the strings 7. This allows the sound board 3 to be constructed as light and as flexible as is practical, without regard for the static tension of the strings 7. In practice, the invention has proven to exhibit a number of other significant improvements, compared with traditionally constructed guitars, said improvements being brought to light elsewhere in this disclosure.

As shown in FIG. 1 and FIG. 2, the invention frees the soundboard 3 from the static tension of the strings 7 by employing a string support structure that does not require any part of the sound box 1 as a structural element. In point of fact, the sound box 1 need not be present in order to mount and tension the strings 7 on the instrument, though it would produce little sound configured in this manner. Instead, the rigid framework 4 provides a structure upon which to mount the sound box 1. This configuration allows the sound box 1 to perform the sole function of producing sound. The other elements that comprise the tension bearing structure include the neck 2, the bridge 5, and the tailpiece 6.

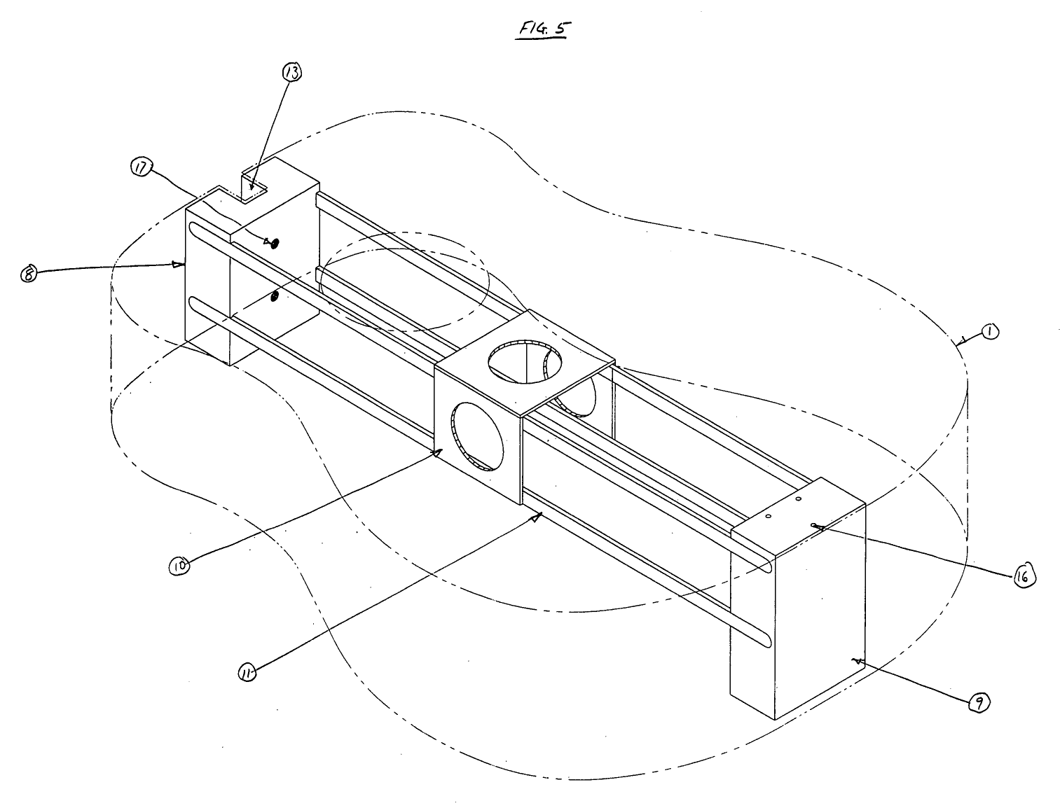

FIGS. 3 and 4 clearly illustrate the complete tension-bearing structure of the instrument with the non-structural elements removed, namely, the sound box 1 and the fretboard. This configuration is amply strong to carry the total tension of the strings 7 (approximately 188 pounds with common, medium gauge strings), and rigid enough to do so without distorting. In this embodiment of the invention, the rigid framework 4 comprises a head block 8, a tail block 9, four carbon fiber rods 11, and several gusset plates 10. The head block 8 is fabricated with a mortise 13 to receive the tenon 12 of the neck 2, and holes to receive the bolts 14 that secure the head block 8 to the neck 2. The head block 8 is held rigidly in a precise, fixed relationship to the tail block 9 by the carbon fiber rods 11. The carbon fiber rods 11 are set into recesses milled into the head block 8 and tail block 9, and secured permanently with a structural adhesive. Gusset plates 10 are permanently fastened to the carbon fiber rods 11, also with a structural adhesive. The gusset plates 10 in this embodiment of the invention are fashioned from thin, aircraft-grade plywood, and substantially increase the torsional stiffness of the assembly. Selective placement and sizing of the gusset plates 10, as well as the weight thereof, can be used to adjust the frequencies at which the assembly resonates in sympathy with the rest of the instrument. This can be useful for filtering undesirable harmonics from the net output of the instrument, as well as enhancing desirable harmonics.

The relative position of the rigid framework 4 within the sound box I is clearly illustrated in FIG. 5. This particular embodiment of the invention employs carbon fiber rods 11 and plywood gusset plates 10 as structural members, in combination with the head block 8 and tail block 9. Other embodiments could utilize alternate materials of sufficient strength and rigidity, some possible substitutes being other fiber/resin composites, metal alloys, and ceramics. Alternately, the structural elements of the invention could be molded or otherwise fabricated as a single component, or as any number of constituent parts as is practical for the purposes of manufacture, with consideration for differing levels of manufacturing capability and the cost thereof.

As illustrated in FIGS. 3 and 4, the tail block 9 component of the rigid framework provides a mounting point for the tailpiece 6, and is drilled to accept the tailpiece mounting screws 15. The rigid mounting of the tailpiece 6 insures that a specific position is maintained for the alignment of the strings 7 and bridge 5.

In FIG. 4, it appears that the bridge 5 is floating in mid-air, suspended only by the strings 7. This is in fact the case, and is an illustration of part of the operating principal of the invention. FIG. 4 shows the actual position of the bridge 5 as it would occur if the sound box was indeed removed. The bridge 5, tailpiece 6, neck 2, and other components are aligned so that the top surface of the soundboard 3 is coplanar with the mounting surface of the bridge 5. Thus constructed, the tensioned strings 7 impose no forces whatsoever on the soundboard 3, except for the vibrations of the strings 7. It is clear that the movement of the soundboard 3 is uninhibited by the static tension of the strings 7.

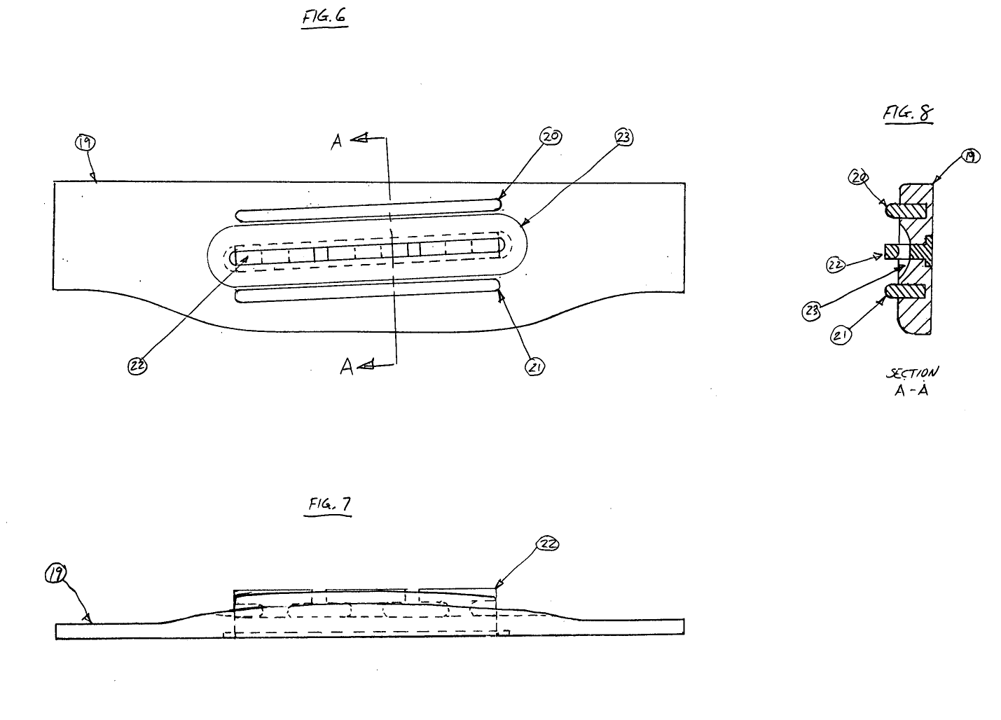

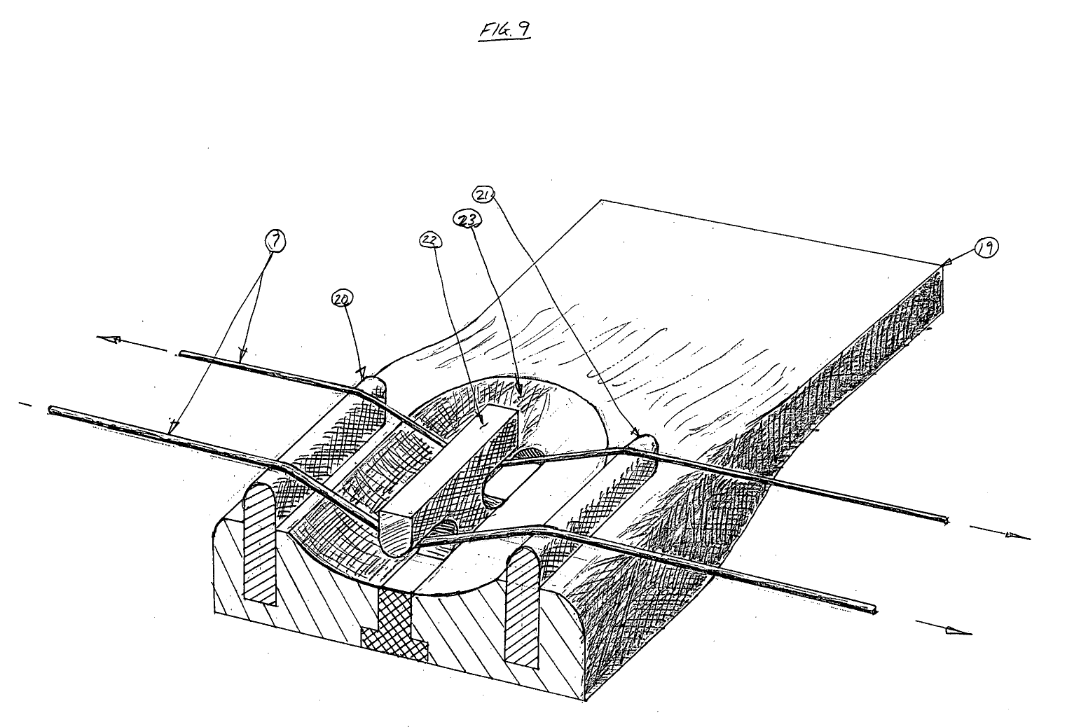

In order to conduct energy from the vibrating strings 7 to the sound board 3 without imposing stresses caused by the static tension of the strings 7, a novel bridge 5 was developed, and is part of the invention disclosed herein. The details of said bridge are illustrated in FIGS. 6, 7, 8, and 9. Traditional acoustic guitar bridges rely on the strings to bear with some degree of pressure on a “saddle”. The strings are held in solid contact with the saddle so that vigorous vibrations will not cause the strings to lose contact with it, however briefly, and thus produce intermittent energy transfer to the sound board 3, otherwise widely characterized as an unpleasant “buzz”. The saddle is mounted solidly in the bridge, which is in turn mounted solidly to the soundboard. In traditional acoustic guitars, the downward pressure that is applied to keep the strings in solid contact with the saddle is also, by design, applied to the soundboard, thus reducing its freedom to vibrate. In the novel bridge disclosed herein, FIGS. 6, 7, 8, and 9, excellent energy conduction between the strings 7 and the soundboard 3 is achieved without imposing downward pressure to the soundboard 3.

FIG. 9 illustrates the path of two strings 7 through the novel bridge assembly, said assembly being ultimately glued solidly to the soundboard 3. As in traditionally constructed guitars, the strings pass over a saddle, in this case, the front saddle 20, which is set into a well-fit slot in the bridge base 19. A second, rear saddle 21 is set into the bridge base 19 so that its top edge is the same height as the front saddle 20. Mid-way between the saddles is a string guide 22, fashioned in such manner as to force the tensioned strings 7 tightly to the top of the saddles 20,21. The bridge base 19 is of sufficient strength to bear the opposing forces caused by the tensioned strings 7 deviation from a straight axis, as are the other components of the assembly. As the forces created within the bridge assembly 5 are contained within the bridge assembly 5, it is possible to align all of the components of the instrument such that the mounting surface of the bridge 5 and the top surface of the soundboard 3 are coplanar with the strings 7 under full tension, with no pressure between the bridge 5 and the soundboard 3. In order to efficiently conduct vibrating string 7 energy to the soundboard 3, the bridge is glued solidly in position.

In this embodiment of the invention, the bridge base 19 is fashioned from high-grade ebony wood. The saddles 20, 21 are animal bone or hard plastic, and the string guide 22 is machined from brass. The use of these materials in a prototype is intended to be aesthetically consistent with traditional guitar making, and is certainly a marketing consideration. However, many other materials, or combination of materials can be used to achieve the same function as the bridge 5 disclosed herein. It is conceivable that all the functionality of the bridge illustrated in this disclosure could be achieved in a single part, or varying numbers of constituent parts as is practical for a particular manufacturing capability and the cost thereof.

The above examples and disclosure are intended to be illustrative and not exhaustive.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Bracing and Bridge System for stringed instruments comprising:
A rigid framework, internal to the sound box, of sufficient strength to bear the total tension of the strings without distortion, structurally independent of the sound box, but providing mounting surfaces for the sound box and neck of the instrument;
A novel “bridge” that directs the vibrating string energy to the sound board without imposing stresses to the soundboard that are due to the static tension of the strings; and
A novel “tailpiece”, that by virtue of its precise alignment and rigid mounting to the rigid frame directs the force of the static tension of the strings to the rigid frame, without imposing stresses to the soundboard that are due to the static tension of the strings, as well as performing the common function of providing an attachment point for one end of the strings.

2. Bracing and Bridge System for stringed instruments as claimed in claim 1 wherein said stringed instrument comprises a neck upon which the player selects notes to be played, as determined by the placement of fingers on the playing surface of the neck, and a resonant chamber, or sound box, the purpose of which is to amplify the vibration of strings set in motion by the player and transmit them through the air as audible sound.

3. Bracing and Bridge System for stringed instruments as claimed in claim 2 wherein said sound box comprises a sound board, a back plate, and a side portion connecting the soundboard to the back plate in such manner as to define a chamber.

4. Bracing and Bridge System for stringed instruments as claimed in claim 1 wherein said rigid framework is contained in its entirety within the sound box enclosure

5. Bracing and Bridge System for stringed instruments as claimed in claim 1 wherein said rigid framework makes no contact with the active portion of the soundboard, back plate, or sides of the sound box

6. Bracing and Bridge System for stringed instruments as claimed in claim 1 wherein said rigid framework comprises the head and tail blocks, and the structural elements that connect them.

7. Bracing and Bridge System for stringed instruments as claimed in claim 1 wherein said bridge is fixed solidly to the soundboard
